(19) United States
(12) Patent Application Publication
(10) Pub. No.: US 2011/0181160 A1
(43) Pub. Date: Jul. 28, 2011

(54) SWITCHING CABINET AND ASSEMBLY METHOD OF THE SAME

(75) Inventors: WEN-TANG PENG, Tu-Cheng (TW); YI-LIANG HSIAO, Tu-Cheng (TW); LEI ZHENG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/852,245

(22) Filed: Aug. 6, 2010

(30) Foreign Application Priority Data
Jan. 25, 2010 (CN) 201010300702.3

(51) Int. Cl. A47B 81/00; B23P 19/04

(52) U.S. Cl. 312/223.1; 29/428

(57) ABSTRACT

A switching cabinet includes a rack. The rack includes two individual frames. Each of the frames includes four braces sequentially coupled together to be rectangle-shaped. The frames are arranged to form front and rear portions of the rack in a depth direction of the rack. An assembly method of the switching cabinet includes steps: 1) providing braces; 2) connecting a part of the braces to form a first frame; 3) connecting the other part of the braces to form a second frame; 4) arranging the first and second frames to form front and rear portions of the switching cabinet in a depth direction of the switching cabinet.

### BACKGROUND

1. Technical Field

The disclosure relates to a switching cabinet and an assembly method of the switching cabinet.

2. Description of Related Art

The framework of a typical switching cabinet usually includes two parallel sides that are assembled first, then the two sides are usually assembled together at left and right portions thereof using cross pieces and fasteners. Although it is not difficult to assemble the sides to desired dimensions, it is difficult to assemble them together with a high degree of accuracy. That is, in process of assembling the two parallel sides together at the left and right portions of the framework using the cross pieces and the fasteners, the distance between the two parallel sides, that is, the width of the switching cabinet, is difficult to meet actual requirements.

What is needed, therefore, is a switching cabinet which overcomes the above-mentioned limitations, and an assembly method of the switching cabinet.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric, assembled view of a switching cabinet in accordance with an embodiment.

FIG. 2 is an isometric, exploded view of the switching cabinet of FIG. 1, wherein the switching cabinet comprises a rack, wherein a front panel is attached at the front of the rack, a rear panel is attached at the rear of the rack and two side panels are respectively attached at left and right sides of the rack.

FIG. 3 is an assembled view of two frames and a plurality of beams of the rack of FIG. 2.

FIG. 4 is an exploded view of the assembly of the frames and the beams of FIG. 3.

FIG. 5 is an isometric, cutaway view of the switching cabinet of FIG. 1.

FIG. 6 is an enlarged view of a circled portion VI of FIG. 5.

FIG. 7 is an enlarged view of a circled portion VII of FIG. 3.

FIG. 8 is a plan view of the rack of FIG. 3, wherein the rack has top and bottom portions of the frames removed to clearly show inner structures thereof.

### DETAILED DESCRIPTION

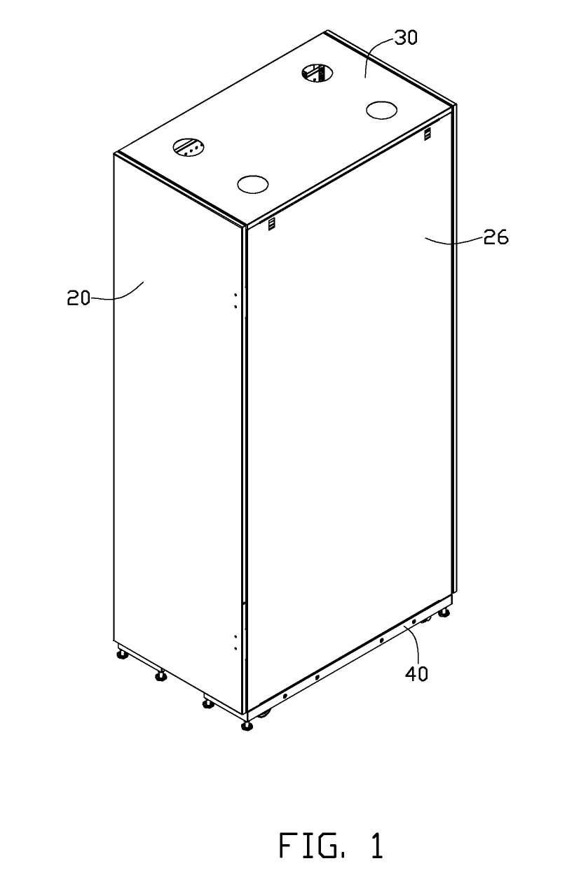

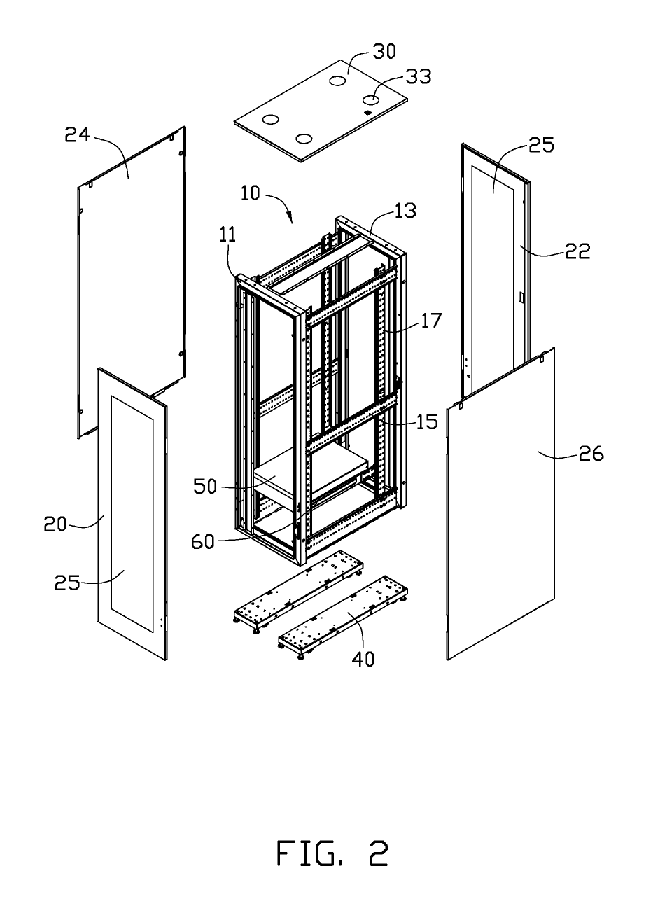

Referring to FIGS. 1-2, a switching cabinet is illustrated in accordance with an embodiment. The switching cabinet comprises a hollow cuboid rack 10, a top cover 30 covering a top of the rack 10 and two parallel pedestals 40 arranged at a bottom of the rack 10. Multiple wheels (not labeled) may be disposed at a bottom of each of the pedestals 40, facilitating movement of the switching cabinet. A front panel 20 is attached at the front of the rack 10, a rear panel 22 is attached at the rear of the rack 10, and two side panels 24, 26 are respectively attached at left and right sides of the rack 10. The front panel 20 and the rear panel 22 each define a vent 25 that are vertically and horizontally aligned with each other. The vents 25 promote or allow airflow through the switching cabinet.

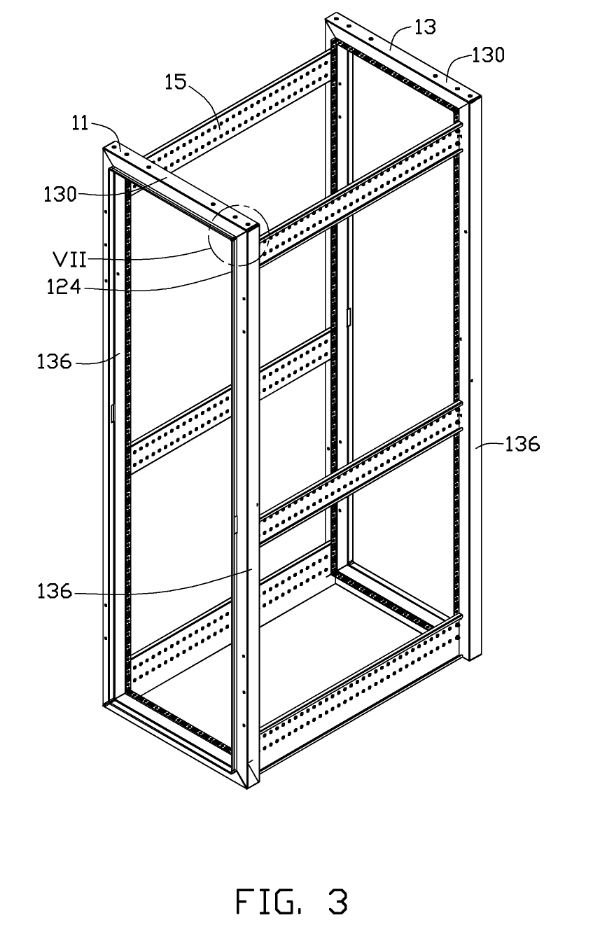

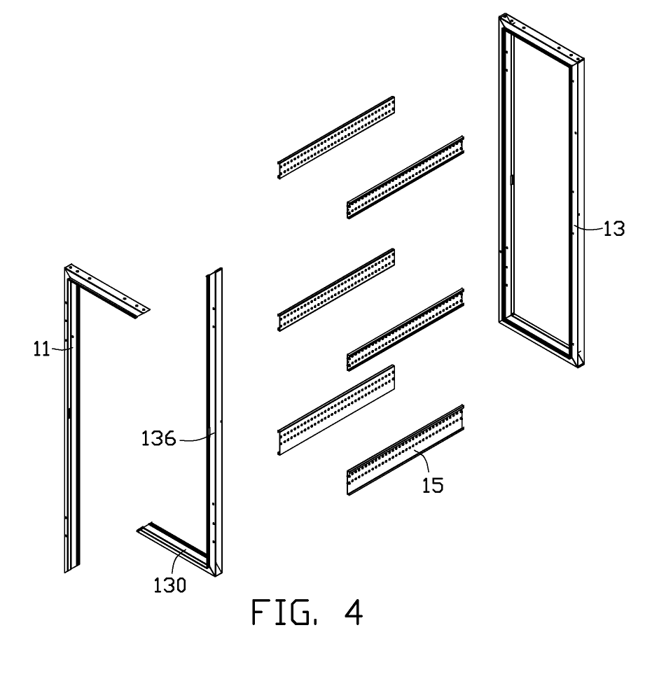

Referring also to FIGS. 3-4, the rack 10 comprises a rectangular front frame 11, a rectangular rear frame 13 spaced from and parallel to the front frame 11, a plurality of beams 15 transversely secured to the front and rear frames 11, 13, and four brackets 17 vertically secured to the beams 15. Two of the brackets 17 are located at the left side of the rack 10, and the other two of the brackets 17 are located at the right side of the rack 10. The beams 15 connect the front frame 11 and the rear frame 13. In order to secure an electronic component 50 onto the brackets 17, two extendable rail assemblies 60 may be horizontally mounted on the brackets 17 located at the left side of the rack 10 and the brackets 17 located at the right side of the rack 10, respectively. In other embodiments, multiple electronic components 50 can be mounted to the brackets 17 by the extendable rail assemblies 60, and stacked vertically within the rack 10. In this embodiment, each electronic component 50 may have a fan (not shown) secured therein that can draw air from the exterior of the switching cabinet into the rack 10 via one of the vents 25 and into the components 50 then exhaust air out of the components 50 and out of the switching cabinet via the other vent 25. It should be noted that the direction from front to back is a depth direction of the rack 10, and the direction from left to right is a width direction of the rack 10.

The front frame 11 has the same configuration as the rear frame 13. The front frame 11 comprises two horizontal braces 130 and two vertical braces 136. The horizontal braces 130 and the vertical braces 136 are sequentially coupled together to cooperatively form the rectangular front frame 11. The braces 130, 136 may be connected by welding or some other fastening means.

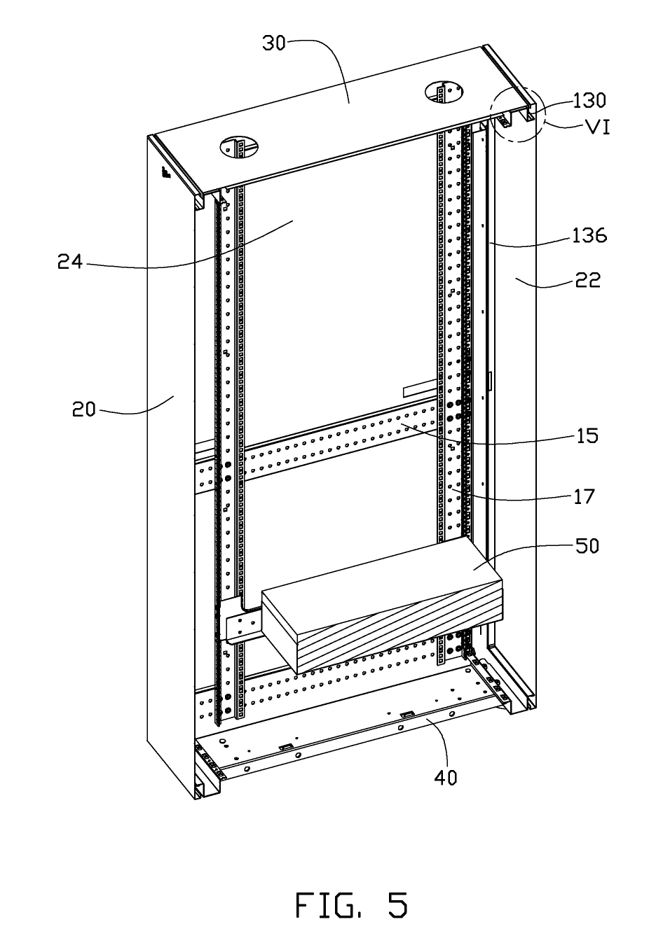

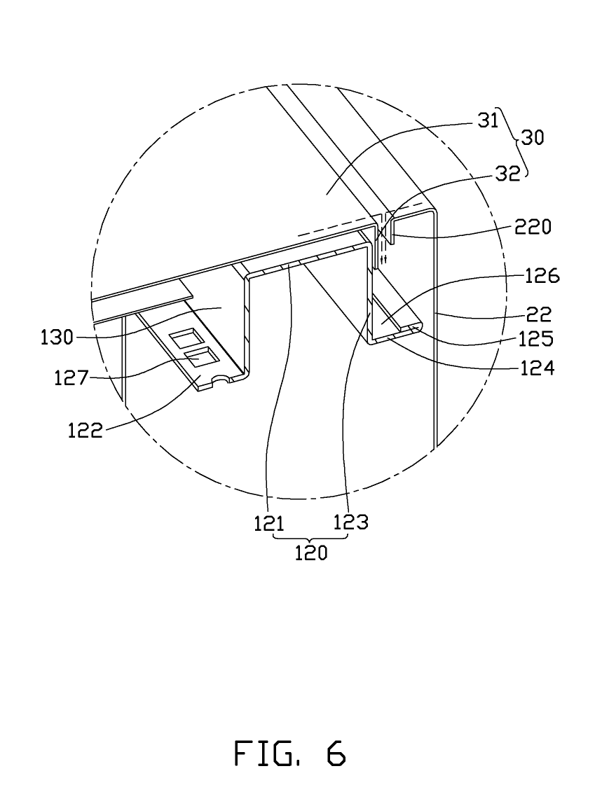

Referring also to FIGS. 5-6, each of the horizontal and vertical braces 130, 136 has a generally C-shaped cross-section, and comprises a main body 120. Each of the main bodies 120 has an open lateral side facing toward center of area framed by the front frame 11. Each of the main bodies 120 comprises a main plate 121, two extending plates 123 extending perpendicularly from two opposite lateral sides of the main plate 121 in a same direction, and a first flange 122 and a second flange 124 extending oppositely and outwardly from free sides of the extending plates 123. The first and second flanges 122, 124 are coplanar with each other. The ratio of the width of the main plate 121 to the width of each of the extending plates 123 is smaller than 2. In some embodiments, the ratio of the width of the main plate 121 to the width of each of the extending plates 123 may be 1 or 1.1. The first and second flanges 122, 124 are parallel to the main plate 121, and perpendicular to the extending plates 123. The first flange 122 extends towards the interior of the rack 10, and the second flange 124 extends towards the exterior of the rack 10. The first flange 122 defines a plurality of mounting holes 127 therein, for securing some elements thereon, for example, some of the beams 15, three beams 15 in this embodiment, are secured on the first flanges 122 of two vertical braces 136 located at the left side of the rack 10, and the other of the beams 15 are secured on the first flanges 122 of two vertical braces 136 located at the right side of the rack 10, when screws (not shown) extend through the beams 15 and engage into the mounting holes 127.

The second flanges 124 of the horizontal and vertical braces 130, 136 each have a free side thereof bent inwardly towards the extending plates 123 to form a baffle plate 125. In this embodiment, the baffle plates 125 are pressed towards the second flanges 124, to make the baffle plates 125 in contact with the second flanges 124, thereby defining grooves 126 between inner edges of the baffle plates 125 and corresponding extending plates 123.

The top cover 30 comprises a top board 31 and two inserting sheets 32 extending perpendicularly and downwardly from two opposite sides of the top board 31. The top board 31 defines a plurality of apertures 33. In this embodiment, multiple fans (not shown) may be seated in the apertures 33, for drawing air into and out of the rack 10.

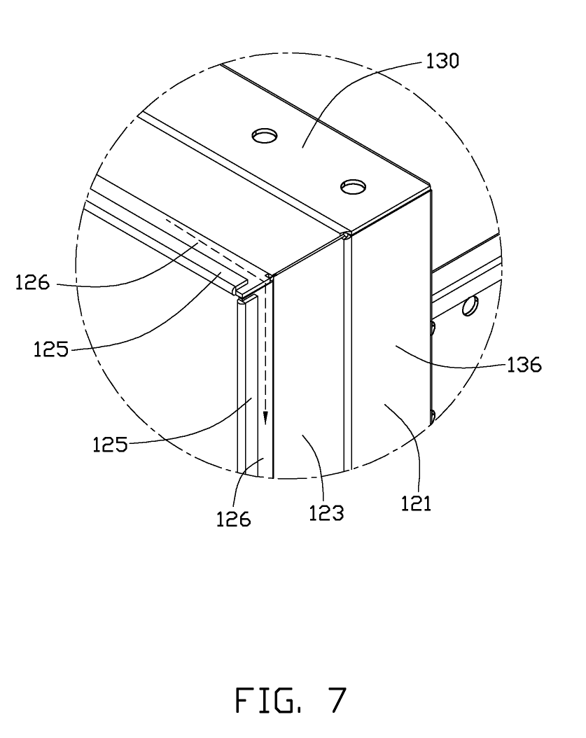

The inserting sheets 32 align with the grooves 126 of the horizontal braces 130 located at the tops of the front and rear frames 11, 13. When liquid such as rain drops on the top board 31, the liquid flows into the grooves 126 located at the tops of the front and rear frames 11, 13 along the inserting sheets 32. Referring also to FIG. 7, the liquid in the grooves 126 located at the tops of the front and rear frames 11, 13 flows out of the switching cabinet along the grooves 126 of the vertical braces 136, preventing the liquid from flowing into the switching cabinet thereby avoiding short circuits. In this embodiment, a guiding plate 220 is bent downwardly from a top of the rear panel 22. The guiding plate 220 guides liquid on the top of the rear panel 22 into the grooves 126 of the rear frame 13. Similarly, a guiding plate (not labeled) similar to the guiding plate 220 of the rear panel 22 is bent inwardly from a top of the front panel 20. The guiding plate of the front panel 20 guides liquid on the top of the front panel 20 into the grooves 126 of the front frame 11.

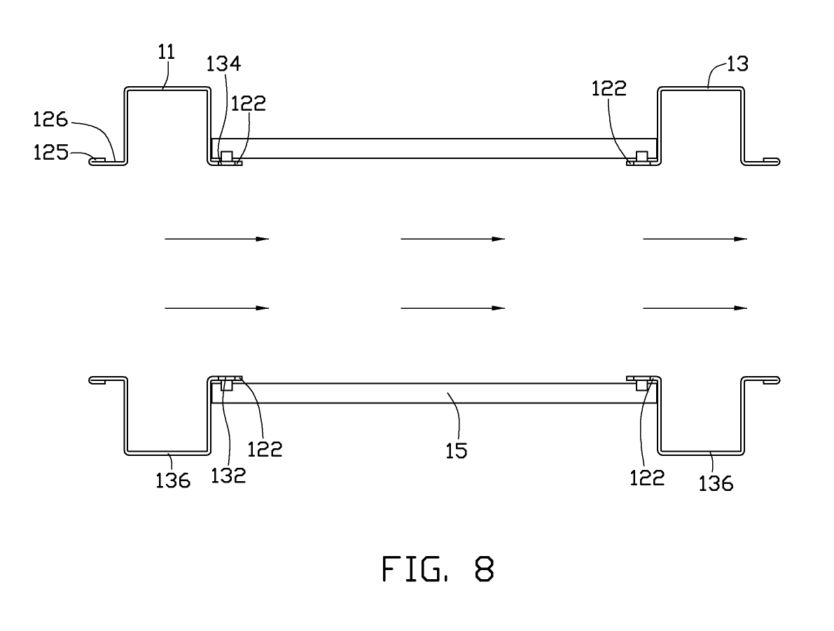

Referring also to FIG. 8, the first flanges 122 of two vertical braces 136 located at the left side of the rack 10 are coplanar with each other to define a first plane 132, the first flanges 122 of two vertical braces 136 located at the right side of the rack 10 are coplanar with each other to define a second plane 134, and the first plane 132 is spaced from and parallel to the second plane 134. That is, the flanges 122 of two adjacent vertical braces 136 which are respectively located at the front and the rear of the rack 10 are coplanar with each other. Due to configuration of the flanges 122, an air passage is defined between the first plane 132 and the second plane 134.

An assembly method of the switching cabinet comprises steps of: a) providing four horizontal braces 130 and four vertical braces 136; b) connecting (by e.g. welding) two horizontal braces 130 and two vertical braces 136 to form the front frame 11; c) connecting (by e.g. welding) the other two horizontal braces 130 and the other two vertical braces 136 to form the rear frame 13; d) arranging the front and rear frames 11, 13 to form at front and rear portions of the switching cabinet in parallel; e) providing six beams 15, and securing transversely the beams 15 to the front and rear frames 11, 13 to form the rack 10; f) mounting the top cover 30 and the pedestals 40 on tops and bottoms of the front and rear frames 11, 13; g) mounting the front panel 20, the rear panel 22 and the side panels 24, 26 to the rack 10.

The front and rear frames 11, 13, the front panel 20, the rear panel 22, the side panels 24, 26, the top cover 30, the pedestals 40 and the beams are separate components and can be stacked vertically to facilitate transportation and save on cost of transportation, and assembled at a destination. In addition, in assembly of the switching cabinet, the front and rear frames 11, 13 are firstly connected to form front and rear portions of the switching cabinet, enabling precise control over the width of the switching cabinet to meet requirements.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A switching cabinet comprising:
a rack comprising two individual frames, each of the frames comprising four braces sequentially coupled together to be rectangle-shaped;
wherein the frames are arranged to form front and rear portions of the rack in a depth direction of the rack.

2. The switching cabinet of claim 1, wherein the braces are sequentially welded to form each of the frames.

3. The switching cabinet of claim 1, wherein each of the braces comprises a substantially C-shaped main body, and the main body has an open lateral side facing toward center of area framed by a corresponding frame.

4. The switching cabinet of claim 3, wherein the two of the braces of each of the frames are vertical, and the other two of the braces of each of the frames are horizontal, four vertical braces of the frames each further comprising a first flange extending towards the interior of the rack from an inner edge of the main body and a second flange extending towards the exterior of the rack from an outer edge of the main body.

5. The switching cabinet of claim 4, wherein two horizontal braces located at a top of the rack each further comprises a third flange extending towards the exterior of the rack from an outer edge of the main body.

6. The switching cabinet of claim 5, wherein the third flange has a free side thereof bent inwardly towards the main body to form a baffle plate, the baffle plate being in contact with the third flange, a groove being defined between an inner edge of the baffle plate and the main body.

7. The switching cabinet of claim 6, wherein the first and second flanges of a same brace are parallel to the main body of the same brace and coplanar with each other.

8. The switching cabinet of claim 6, further comprising a top cover covering the top of the rack, wherein the top cover comprises a top board and two inserting sheets extending downwardly from two opposite sides of the top board, the inserting sheets respectively corresponding to the grooves of the two horizontal braces located at the top of the rack to guide liquid on the top board into the grooves.

9. The switching cabinet of claim 8, wherein the second flange forms a groove similar to the groove of the third flange, the liquid in the grooves of the two horizontal braces located at the top of the rack flows into the grooves of the vertical braces and flows out of the switching cabinet.

10. The switching cabinet of claim 5, wherein the main body comprises a main plate and two extending plates extending perpendicularly from two opposite lateral sides of the main plate in a same direction, the first flange connecting with one of the extending plates located at an inner side of a corresponding brace, the second flange connecting with the other one of the extending plates located at an outer side of a corresponding brace, the third flange connecting with one of the extending plates located at an outer side of a corresponding brace.

11. The switching cabinet of claim 5, wherein the first flanges of two vertical braces located at a left side of the rack being coplanar with each other to define a first plane, the first flanges of the other two vertical braces located at a right side of the rack being coplanar with each other to define a second plane, the first plane being spaced from and parallel to the second plane.

12. An assembly method for a switching cabinet comprising steps of:
providing a plurality of braces;
connecting a part of the braces to form a first frame;
connecting the other part of the braces to form a second frame; and
arranging the first and second frames to form front and rear portions of the switching cabinet in a depth direction of the switching cabinet.

13. The assembly method of claim 12, wherein each of the first and second frames comprises four braces, two braces being vertical, and the other two braces being horizontal, the braces of each of the first and second frames being sequentially welded.

14. The assembly method of claim 13, further comprising a step of securing a plurality of beams to the vertical braces of the first and second frames.

15. The assembly method of claim 13, wherein each of the beams has an end thereof secured to one of the vertical braces of the first frame and an opposite end thereof secured to one of the vertical braces of the second frame, the one of the vertical braces of the second frame facing the one of the vertical braces of the first frame.

16. The assembly method of claim 12, further comprising a step of mounting a top cover and a pedestal on tops and bottoms of the first and second frames.
